(19) United States
(12) Patent Application Publication
(10) Pub. No.: US 2006/0013833 A1
(43) Pub. Date: Jan. 19, 2006

(54) Thermal stabilization of biocides in matrix compositions processed at elevated temperatures

(75) Inventor: Joseph P. Bartko, Nazareth, PA (US)

Correspondence Address: INTERNATIONAL SPECIALTY PRODUCTS;Attn: William J. Davis, Esq., Building NO. 8, 1361 Alps Road, Wayne, NJ, 07470, US

(73) Assignee: ISP INVESTMENTS INC.

(21) Appl. No.: 10/893,008

(22) Filed: Jul. 16, 2004

(51) Int. Cl. A01N 43/38; A01N 47/10

(52) U.S. Cl. 424/400; 514/417; 514/479

(57) ABSTRACT

A composition includes (a) a matrix, (b) a biocide, and (c) an antioxidant, in which said biocide exhibits thermal stability at matrix processing temperatures up to 250° C.

### BACKGROUND OF THE INVENTION

1. Field of the Invention

This invention relates to thermal stabilization of biocides in a matrix composition processed at elevated temperatures, and, more particularly, to the use of an antioxidant to stabilize the biocide in the matrix.

2. Description of the Prior Art

The use of an antioxidant to improve the thermal stability of plastics is well known in the art. However, when a biocide is introduced into such plastics, especially clear plastics, thermal degradation of the biocide occurs at the processing temperature of the plastic, which tends to discolor the plastic resulting in less biocide efficacy.

Accordingly, it is an object of this invention to provide a composition of a matrix, a biocide and an antioxidant, in which the biocide exhibits thermal stability at matrix processing temperatures of up to 250° C.

### SUMMARY OF THE INVENTION

What is described herein is a composition which includes (a) a matrix, (b) a biocide, and (c) an antioxidant, in which said biocide exhibits thermal stability at matrix processing temperatures of up to 250° C.

Suitably (a) is a plastic, e.g. a polyolefin, polyvinyl chloride, polyurethane, or a wood-plastic composite, and the like.

Typical biocides (b) include N-(trichloromethylthio) phthalimide, and N-trichloromethylthio-tetrahydrophthalimide and N-haloalkylthio compounds including dichlorofluamide, captofol, fluorfolpet, tolylfluamide and sulphenylated urea derivatives; 3-iodopropynyl butylcarbamate, 3-iodopropynylcarbamate, or 3-iodopropynyl-N-phenylcarbamate, and the like.

Representative antioxidants (c) include a hindered phenol, an amine or azole, a mixture of a hindered phenol an aryl phosphate, and the like.

Preferably (b) is present in an amount, by weight, of about 0.1-1%, of the composition, most preferably, 0.2-2%.

### DETAILED DESCRIPTION OF THE INVENTION

### Example 1

In a typical run, a composition of a matrix of polypropylene, 0.75 wt. % of the biocide Fungitrol® 11 (ISP), and 1% of the antioxidant Naugard® B-25 was processed in a Brabender Plasticorder at 215° C. There was no color change in the composition after heating for 30 minutes. A Control composition of polypropylene and Fungitrol® 11 (ISP), without antioxidant, developed a tanish cast after only 3-6 minutes at 215° C.

Fungitrol® 11 is N-(trichloromethylthio) phthalimide.

Naugard® is a hindered phenol.

### Example 2

A flexible polyvinyl chloride matrix with 0.25 wt. % Fungitrol® 11 and 0.87% Naugard® processed at 175° C. retained its clarity even after 18-20 minutes heating. A Control of PVC and Fungitrol® 11 degraded in color after only 6 minutes at the processing temperature.

### Example 3

Similar advantageous results with respect to no color change were obtained with Fungitrol® 11 or IPBC biocide in polyethylene and wood-plastic composite matrixes processed at elevated temperatures.

### Example 4

Examples 1-3 were repeated with compositions containing colorants, heat and light stabilizers, anti-static agents, and coupling agents with similar results.

While the invention has been described with particular reference to certain embodiments thereof, it will be understood that changes and modifications may be made which are within the skill of the art. Accordingly, it is intended to be bound only by the following claims, in which:

What is claimed is:

1. A composition comprising:
(a) a matrix,
(b) a biocide, and
(c) an antioxidant,
in which said biocide exhibits thermal stability at matrix processing temperatures up to 250° C.

2. A composition according to claim 1 wherein (a) is a plastic.

3. A composition according to claim 1 wherein (a) is a polyolefin.

4. A composition according to claim 1 wherein (a) is polyvinyl chloride or polyurethane.

5. A composition according to claim 1 wherein (a) is a wood-plastic composite.

6. A composition according to claim 1 wherein (b) is selected from N-(trichloromethylthio) phthalimide, N-trichloromethylthio-tetrahydrophthalimide and N-haloalkylthio compounds including dichlorofluamide, captofol, fluorfolpet, tolylfluamide and sulphenylated urea derivatives.

7. A composition according to claim 1 wherein (b) is 3-iodopropynyl butylcarbamate, 3-iodopropynylcarbamate, or 3-iodopropynyl-N-phenylcarbamate, and the like.

8. A composition according to claim 1 wherein (c) is a hindered phenol, an amine or azole.

9. A composition according to claim 1 wherein (c) is a mixture of a hindered phenol an aryl phosphate.

10. A composition according to claim 1 wherein (b) is present in an amount, by weight, of about 0.1-1%.

11. A composition according to claim 1 wherein (c) is present in an amount of 0.2-2%.
